(19) United States
(12) Patent Application Publication
(10) Pub. No.: US 2002/0097149 A1
(43) Pub. Date: Jul. 25, 2002

(54) Caution lights on motor vehicles

(76) Inventor: Harold E. Caplan, Houston, TX (US)

Correspondence Address: Murray Nadler, Eaq., Patent Attorney, 3823 Oberlin, Houston, TX, 77005, US

(21) Appl. No.: 10/023,179

(22) Filed: Dec. 17, 2001

Related U.S. Application Data
(60) Provisional application No. 60/263,664, filed on Jan. 23, 2001.

(51) Int. Cl. B60Q 1/26

(52) U.S. Cl. 340/468; 340/539

(57) ABSTRACT

A system comprised of caution lights mounted on a motor vehicle that are visible to operators of following vehicles wherein the caution lights can be turned on by the motor vehicle operator by closing either an electrical switch in a battery circuit providing power to the caution lights or closing a relay switch in the battery circuit, wherein the relay is actuated by a radio frequency receiver that is actuated by a radio signal sent to the receiver from a radio transmitter that is actuated by the motor vehicle operator

This patent application is based on Provisional U.S. Application No. 60/263,664 filed on Jan. 23, 2001 for the invention titled YELLOW CAUTION LIGHT ON CARS, VANS AND TRUCKS by applicant Harold E. Caplan

### FIELD OF THE INVENTION

This invention relates to caution lights on motor vehicles.

### BACKGROUND OF THE INVENTION

Currently the first warning that a motor vehicle operator gives drivers behind him that the operator is about to slow down or stop abruptly occurs when the operator presses down on the brake pedal which causes the brake lights on the back of the vehicle to light up. Unfortunately, the vehicle in front is already slowing down when the driver in back first sees the brake lights come on because the operator has removed his foot from the accelerator. Depending on the vehicle speed and the distance between the vehicles, the reaction time of the driver in back to brake his vehicle may be too long to avert rear end collision.

In most emergency situations the operator in front can see that a condition or obstruction ahead may force him to make an abrupt stop before the operator removes his foot from the accelerator and presses down on the brake pedal turning on the brake lights. Also the operator can encounter a situation that will require him to take evasive action without braking. Clearly, a devise is required on all motor vehicles to warn following drivers when the lead operator knows that he will soon have to brake or take aversive action that there is peril ahead for the trailing operators.

The warning lights can also be turned on by the operator during foggy periods of reduced visibility to supplement the rear lights.

### SUMMARY OF INVENTION

The present invention is a system that includes one or more caution lights mounted on a motor vehicle so that light from the caution lights is visible to the drivers of vehicles behind. The caution lights can be turned on by the motor vehicle operator from his driving position when the motor vehicle operator determines that he will soon have to brake his vehicle and turned off when the danger recedes.

### DESCRIPTION OF INVENTION

The present invention is a system that includes one or more caution lights mounted on a motor vehicle such that when electric power to the caution lights is turned they emit light that is clearly visible to drivers following. The caution lights are powered by a battery that is connected to the warning lights with an electrical wire, typically an 18 gage wire. The caution lights are turned on by the motor vehicle operator by closing a switch in the power circuit from the battery to the caution lights and off by opening the switch. The switch is located so that it can be actuated by the operator while driving.

The color of the warning lights is preferably yellow since that is the color traditionally associated with motor vehicle warnings.

The power switch can a simple switch in the battery circuit that can be manually opened and closed.

Alternatively, the warning lights can be turned on and off using a radio frequency transmission system such as used in garage door openers. The switch is a relay in the circuit that brings power from the battery to the warning lights which opens and closes, alternately in toggle mode, when a radio frequency receiver on the relay receives a radio signal from a radio transmitter that is activated by the motor vehicle operator.

The radio transmitter or manual switch is located so that the motor vehicle operator can activate it safely while driving. It can be portable, or mounted on the steering wheel, or dashboard, or installed in a visor. The radio signal from the radio transmitter is customized to uniquely actuate the receiver.

Typically, the battery power for the warning lights is tapped off from the battery system at a distribution bolt located under the hood. Typically, the warning light power system is protected against short circuits by a fuse/holder, typically 15 amps.

The warning lights can also be turned on during foggy periods of reduced visibility to supplement the tail lights.

### SUMMARY OF INVENTION

The present invention is one or more caution lights mounted on the rear of a motor vehicle to be visible to drivers of vehicles behind, which can be turned on by the motor vehicle operator from his driving position when the motor vehicle operator determines that he will soon have to slow down or stop his vehicle.

### DESCRIPTION OF INVENTION

The present invention is one or more light fixtures mounted on the rear of a motor vehicle such that when electric power to the lights is turned on their light is clearly visible to drivers following. The caution lights are electrically wired to the vehicle's on board battery system, typically with 18 gage wire. The caution lights are turned on by the motor vehicle operator by closing a switch in the power circuit from the battery to the caution lights. The switch is located so that it can be activated by the operator while driving.

The color of the warning lights is preferably yellow since that is the color traditionally associated with motor vehicle warnings.

What is claimed is:

1. One or more caution lights mounted on a motor vehicle so that when power to the caution lights is turned on light from the caution lights is visible to drivers of following vehicles, wherein the caution lights are connected to a battery power system in the motor vehicle by an electrical wire circuit that contains a switch that can be opened and closed by the operator of the vehicle while driving to turn the caution lights on and off.

2. One or more caution lights mounted on a motor vehicle so that when power to the caution lights is turned on light from the caution lights is visible to drivers of following vehicles, wherein the caution lights are connected to a battery power system in the motor vehicle by an electrical wire circuit that contains a relay that is alternately opened and closed when the relay is actuated by a radio signal from a radio signal transmitter that can be actuated by the motor vehicle operator.
